(19) United States
(12) Patent Application Publication
(10) Pub. No.: US 2026/0339681 A1
(43) Pub. Date: Oct. 29, 2026

(54) METHOD AND APPARATUS FOR INFORMATION PROCESSING

(71) Applicant: BEIJING ZITIAO NETWORK TECHNOLOGY CO., LTD., Beijing (CN)

(72) Inventors: Liyue ZHAO, Beijing (CN); Wenhai YANG, Beijing (CN); Ling QIU, Beijing (CN); Bin KANG, Beijing (CN); Shichao MA, Beijing (CN)

(21) Appl. No.: 19/109,534

(22) PCT Filed: Nov. 20, 2023
(86) PCT No.: PCT/CN2023/132720

§ 371 Date: Mar. 6, 2025

(30) Foreign Application Priority Data
Jan. 13, 2023 (CN) 202310074225.0

(51) Int. Cl. G06F 9/451; G06F 3/0484

(52) U.S. Cl. CPC G06F 9/451; G06F 3/0484

(57) ABSTRACT

Embodiments of the disclosure provide a method and an apparatus for information processing, and the method includes: displaying, in a display interface, target content information; and in response to a display operation, displaying, in a predetermined region of the display interface, entry information of a plurality of entries associated with the target content information.

### CROSS-REFERENCE TO RELATED APPLICATIONS

This application is a U.S. national stage application of International Patent Application No. PCT/CN2023/132720, filed on Nov. 20, 2023, which claims priority to Chinese Patent Application No. 202310074225.0, filed on Jan. 13, 2023, and entitled “METHOD AND APPARATUS FOR INFORMATION PROCESSING”, the contents of which are incorporated herein by reference in their entireties.

### FIELD

Embodiments of the present disclosure relate to the field of Internet technologies, and in particular, to a method and an apparatus for information processing.

### BACKGROUND

For information communication, rich text information may be edited in a document or an instant messaging tool. The rich text information may include text content, picture content, video content, or the like.

To understand the rich text information, a user usually reads the full content of a text, browses all the content of an image, or watches the content of a video. The rich text information may include some words difficult to understand, such as professional terminology and the like. When browsing the rich text information, the user may browse the words difficult to understand one by one. In some application scenarios, to better understand the rich text information, for the words difficult to understand, a user may look up a relevant dictionary or search for the definition of these words through the web when browsing each of these words.

### SUMMARY

The embodiment of the present disclosure provides a method and an apparatus for information processing.

According to a first aspect, the embodiments of the present disclosure provide a method for information processing, comprising: displaying, in a display interface, target content information; and in response to a display operation, displaying, in a predetermined region of the display interface, entry information of a plurality of entries associated with the target content information.

According to a second aspect, the embodiments of the present disclosure provide an apparatus for information processing, comprising: a first display unit configured to display, in a display interface, target content information; and a second display unit configured to, in response to a display operation, display, in a predetermined region of the display interface, entry information of a plurality of entries associated with the target content information.

According to a third aspect, the embodiments of the present disclosure provide an electronic device, comprising: a processor and a memory; the memory storing computer-executable instructions; wherein the processor executes the computer-executable instructions stored in the memory, causing the processor to perform the method for information processing of the first aspect and various implementations.

According to a fourth aspect, the embodiments of the present disclosure provide a computer-readable storage medium, wherein the computer-readable storage medium stores computer-executable instructions which, when executed by a processor, implement the method for information processing of the first aspect and various implementations.

According to a fifth aspect, the embodiments of the present disclosure provide a computer program product, comprising a computer program, wherein the computer program, when executed by a processor, implements the method for information processing of the first aspect and various implementations.

According to the method and apparatus for information processing provided by the embodiments of the present disclosure, target content information is displayed in a display interface; and in response to a display operation, entry information of a plurality of entries associated with the target content information is displayed in a predetermined region of the display interface. In this way, without needing to read through the target content information, a user may gain a condensed understanding of the plurality of entries associated with the target content information through the entry information displayed in the predetermined region, which facilitates rapid comprehension of the target content information for the user.

### BRIEF DESCRIPTION OF DRAWINGS

To more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is a schematic diagram of an application scenario in the related art;

FIG. 2 is a schematic flowchart 1 of the method for information processing according to the present disclosure;

FIG. 3 is a schematic diagram of some application scenarios of the method for information processing according to the present disclosure;

FIG. 4 is a schematic diagram of some application scenarios of the method for information processing according to the present disclosure;

FIG. 5 is a schematic diagram of some application scenarios of the method for information processing according to the present disclosure;

FIG. 6 is a schematic diagram of some application scenarios of the method for information processing according to the present disclosure;

FIG. 7 is a schematic diagram of some application scenarios of the method for information processing according to the present disclosure;

FIG. 8 is a schematic flowchart 2 of the method for information processing according to the present disclosure;

FIG. 9 is a schematic diagram of some application scenarios of the method for information processing according to the present disclosure;

FIG. 10 is a schematic diagram of some application scenarios of the method for information processing according to the present disclosure;

FIG. 11 is a schematic diagram of some application scenarios of the method for information processing according to the present disclosure;

FIG. 12 is a schematic diagram of some application scenarios of the method for information processing according to the present disclosure;

FIG. 13 is a schematic diagram of some application scenarios of the method for information processing according to the present disclosure;

FIG. 14 is a structural block diagram of an apparatus for information processing according to the present disclosure; and

FIG. 15 is a schematic diagram of the hardware structure of an electronic device according to the embodiments of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. It is clear that the embodiments described are part of the present disclosure and not all embodiments. Based on the embodiments in the present disclosure, all other embodiments obtained by those skilled in the art without creative labor fall within the scope of the protection of the present disclosure.

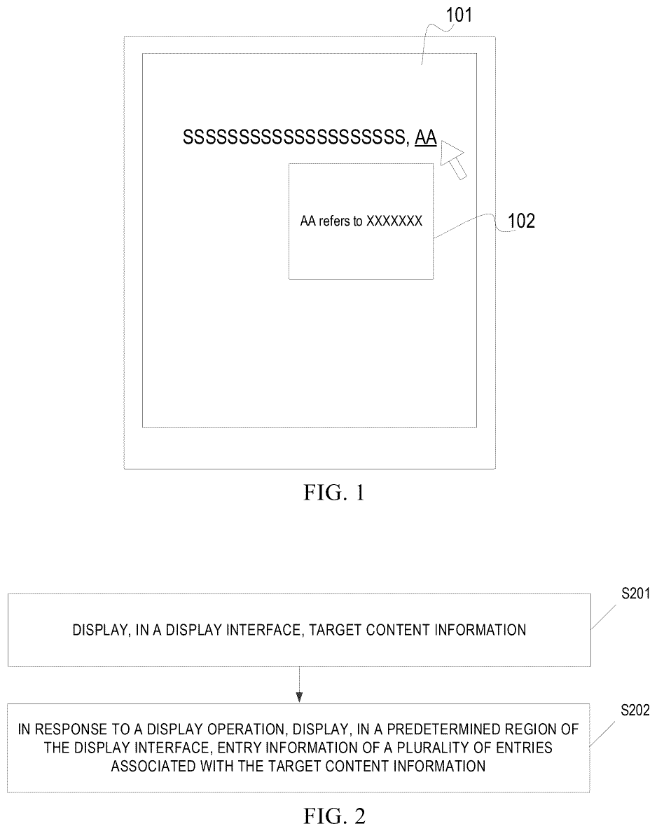

Generally, to assist a user in understanding rich text information for information interaction, in the related art, a hyperlink may be set for an entity word appearing in a document that matches a predetermined entry library, so that the user views an entry definition corresponding to the entity word. FIG. 1 is a schematic diagram of an application scenario in the related art. As shown in FIG. 1, an entity word AA appearing in a document 101 matches an entry AA in a predetermined entry library, and a hyperlink may be set for the entity word AA. When browsing the entity word AA, a user may click the entity word AA, so that a definition corresponding to the entry AA may be displayed in a pop-up window 102.

However, in the related art, a user can only obtain the definition corresponding to an entity word by reading through a document and clicking on the entity word when encountering the entity word. The user needs to read through the document and browse the information of respective entity words one by one, which is not conducive for the user to collectively view a plurality of entries involved in the document. In addition, in the foregoing manner, the user intermittently searches for entry definitions during browsing of the document will affect the speed at which the user understands the content of the entire document.

To help a user more effectively understand a document, in the present disclosure, entry information of a plurality of entities associated with the content information is displayed in a display interface displaying target content information, so that the user collectively browses, in the display interface, the entry information of the plurality of entries associated with the target content information. Therefore, the user may intuitively know the plurality of entries associated with the target content information through the entry information without reading the target content information, thereby helping the user to quickly understand the content of a document.

FIG. 2 is a schematic flowchart 1 of the method for information processing according to the embodiments of the present disclosure. As shown in FIG. 2, the method for information processing comprises the following steps.

S201: Target content information is displayed in a display interface.

The executing entity of the method for information processing of the present disclosure may be a terminal device or a server providing display information for a terminal device. The following is illustrated with the executing entity as a terminal device.

The target content information may be rich text information. The target content information may include text content, image content, and/or video content.

The terminal device may run a predetermined client, and the display interface herein may be a display interface of a predetermined client. In addition, the display interface may be a display interface corresponding to webpage content.

In an example, the predetermined client may be a client of an instant messaging application, and the target content information may be content information in an instant messaging session, for example, content information currently viewed by a user in an instant messaging session.

In an example, the webpage content includes an instant messaging session in a webpage, and the target content information may be at least part of content information in an instant messaging session in a webpage.

In an example, the predetermined client may be a client of a collaborative office application, and the target text may be text corresponding to a collaborative office document.

In an example, the webpage content includes an online document, and the target text may be at least part of text of an online document.

S202: In response to a display operation, entry information of a plurality of entries associated with the target content information is displayed in a predetermined region of the display interface.

In an example, an entry display control may be displayed in the display interface of the terminal device, and the display operation may be a trigger operation performed by a user on the entry display control.

The predetermined region may be a region in the display interface that is outside of the region where the target content information is displayed.

In an example, the display interface may have two different display regions. The target content information is displayed in one area, and the entry information of the plurality of entries associated with the target content information is displayed in another region. Another region herein is the predetermined region. For example, the predetermined region may be a region on the right side of the display region of the target content information.

Here, the plurality of entries associated with the target content information may be an entity word entry appearing in the target content information; or may be an entry related to the entity word appearing in the target content information, for example, an entry commonly appearing with an entity word which appears in the target content information, or the like, or an associated entry associated with an entity word appearing in the target content information determined in a knowledge graph, or the like.

The entry associated with the target content information is displayed in the predetermined region, to help the user understand the target content information.

In this embodiment, target content information is displayed in a display interface; and in response to a display operation, entry information of a plurality of entries associated with the target content information is displayed in a predetermined region of the display interface. In this way, without needing to read through the target content information, a user may gain a condensed understanding of the plurality of entries associated with the target content information through the entry information displayed in the predetermined region, which facilitates rapid comprehension of the target content information for the user.

In some embodiments, the plurality of entries belong to a plurality of categories, and the step S202 comprises: displaying the entry information of the plurality of entries by category; and/or displaying an entry list comprising at least part of content of respective entries in the plurality of entries.

In an example, the entry information of the plurality of entries may be displayed in the predetermined region by category.

In an example, the above categories include, but are not limited to: inappropriate expression, not recommended for use, supplemental definition, polysemy, and the like.

An entry belonging to the inappropriate expression category herein may be an entry promoting negative values, a harmful entry, or an entry with personal offensive content, or the like, in the entry. For an entry that belongs to the inappropriate expression category, an editor of the target content information is often required to modify or delete the entry.

An entry belonging to the category not recommended for use may be an entry with a negative impact, or an entry that is not well-known to most people. For an entry in the category not recommended for use, an editor of the target content information may decide to delete, modify, or retain the entry by confirming again.

The supplemental definition may be, for example, an entry definition supplemented by a user logging into the display interface described above.

The polysemy may be an entry with a plurality of definitions. The entries may include a plurality of polysemous entries.

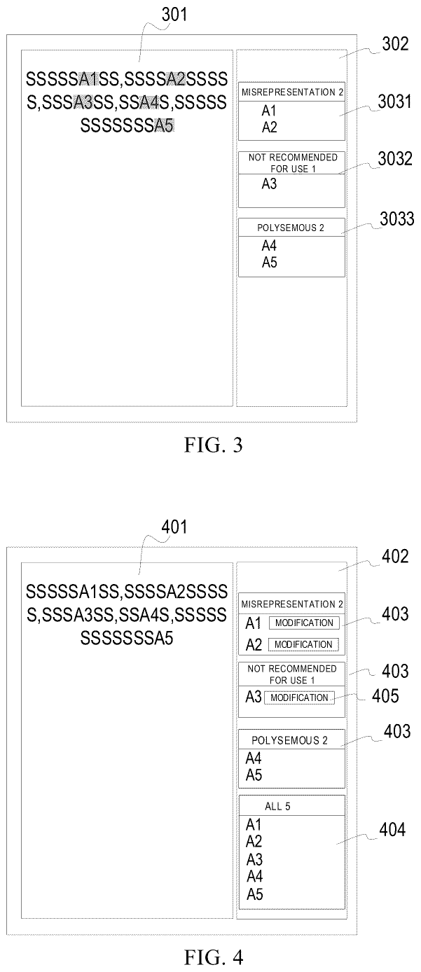

FIG. 3 is a schematic diagram of an application scenario of the method for information processing according to the present disclosure. As shown in FIG. 3, target content information may be displayed in a display region 301 of target content information in a display interface, and entry information of a plurality of entries associated with the target content information may be displayed in a predetermined region 302. An entry information display window may be displayed in the predetermined region 302. The entry information display window may include a plurality of sub-display regions, such as sub-display regions 3031, 3032, and 3033 in FIG. 3. Different categories of entry information may be displayed in different sub-display regions. For a sub-display region corresponding to a category, a category identifier of the category and entry information of at least one entry belonging to the category may be displayed in the sub-display region. The entry information of the at least one entry displayed in a sub-display region may include a category identifier corresponding to the sub-display region and entry information of at least one entry belonging to the category identifier. The category identifier “misrepresentation” and information of entries “A1, A2” belonging to the “misrepresentation” category are shown in a sub-display region 3031 in FIG. 3. A category identifier “not recommended for use” and information of entry “A3” belonging to the “not recommended for use” category are displayed in the sub-display region 3032. A category identifier “polysemy” and information of entries “A4, A5” belonging to the “polysemy” category are displayed in the sub-display region 3033. For each category, the number of entries included in the category may also be displayed at the category identifier of the category. As shown in FIG. 3, “2” of “misrepresentation 2” refers to an entry in the target content information that involves 2 misrepresentation categories. The number of other category identifiers may be analogized. In addition, entries in the target content information displayed in the display region of the target content information may be highlighted. As shown in FIG. 3, the background color corresponding to the entries A1, A2, A3, A4, and A5 in the target content information displayed in the display region 301 of the target content information is different from the background color of other words in the target content information.

In some embodiments, the method for information processing further comprises: displaying, in the predetermined region, a modification control for indicating modification of an entry belonging to the inappropriate expression category and/or the category not recommended for use.

In these embodiments, since the entries involved in the target content information are displayed by category, on the one hand, the editor of the target content information may be presented with which categories of entries are included in the edited content information, to facilitate the editor to manage the content information, and on the other hand, the editor may be prompted to revise part of the entries through the category information, so that the time for the editor to review the edited target content information may be saved.

In some embodiments, the predetermined region may further include an entry list for displaying all entries involving the target text. At least part of the content of each entry may be included in the entry list.

As an implementation, in addition to displaying the entry information of the plurality of entries in the predetermined region by category, the entry list of all entries involving the target text may be collectively displayed in the predetermined region.

FIG. 4 is a schematic diagram of an application scenario of the method for information processing according to the present disclosure. As shown in FIG. 4, a display region 401 of target content information in a display interface may display the target content information, and the predetermined region 402 may display the foregoing entry information. The predetermined region 402 may display an entry information display window. The entry information display window may include a plurality of sub-display regions 403. Different categories of entry information may be displayed in different sub-display regions 403. For the sub-display region 403 corresponding to a category, a category identifier and entry information of at least one entry belonging to the category may be displayed in the sub-display region 403.

In addition, the categories involving the plurality of entries may include “inappropriate expression”, “not recommended for use”, “polysemy”, and the like. For the inappropriate expression category and the category not recommended for use, a modification control 405 for indicating modification of these entries may also be displayed in a predetermined region, such as a modification control identified as “modification” in FIG. 4. For each entry belonging to the inappropriate expression category and the category not recommended for use, a user may perform a trigger operation on the modification control to modify and/or delete the entry.

In addition, the entry display window further includes a sub-display region 404, and an identifier “all” is displayed in the sub-display region 404 to indicate that the sub-display region displays an entry list comprising all entries associated with the target content information. The entry list displayed in the sub-display region 404 includes entries A1, A2, A3, A4, and A5 associated with the target content information. The entry list includes entries that may be displayed in the sub-display region 403.

In these embodiments, all entry information involving the target text may be collectively displayed in the entry list. This helps a user quickly know which entries in the target text are difficult to understand, and helps the user to quickly understand the target text.

In some embodiments, the method for information processing further includes the following steps.

Firstly, in response to receiving a display instruction executed on an entry, a display window of the entry is displayed.

Secondly, definition information of the entry is displayed in the display window.

As an implementation, receiving the display instruction may include receiving a trigger operation performed by a user on the entry name of the entry displayed in the entry information display window.

The display window herein may include a pop-up window or a floating window.

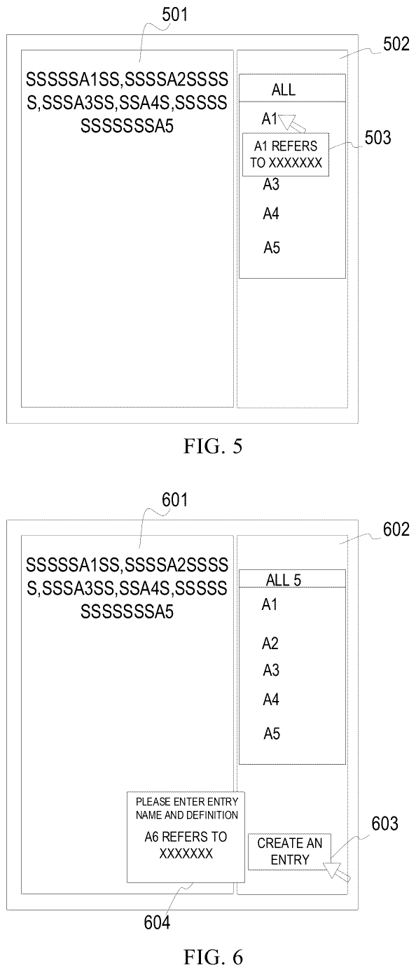

FIG. 5 is a schematic diagram of an application scenario of the method for information processing according to the present disclosure. As shown in FIG. 5, a display region 501 of target content information in a display interface may display the target content information, and a predetermined region 502 may display entry information of a plurality of entries associated with the target content information. The entry information displayed in the predetermined region 502 may include entry information of entries A1, A2, A3, A4, A5, and so on associated with the target content information. A user may perform a click operation on any entry displayed in the predetermined region 502, for example, the information of the entry A1, to send a display instruction to the executing entity, the executing entity may display a display window 503, and display the definition of the entry A1 in the display window.

It should be noted that definitions of respective entries may be predefined, and the definitions of respective entries may be stored in a predetermined entry library. In some application scenarios, the predetermined entry library may be an encyclopedia entry library.

In these embodiments, a user may operate on the entry information displayed in the predetermined region to display a definition of an entry. The user may collectively view the definitions of the plurality of entries involving the target content information in the predetermined region, thereby improving the convenience of viewing the definitions of the plurality of entries involved in the target content information.

In some embodiments, the method for information processing further comprises the following steps.

Firstly, an entity word added or reduced in the target content information is detected during an editing process of the target content information.

Secondly, in accordance with a determination that the entity word matches a predetermined entry library, an entry corresponding to the entity word is dynamically added or reduced in the predetermined region, based on a detection result.

The addition of the entity word of the target content information refers to that a new entity word that is not present in the target content information occurs during the editing process. The reduction of the entity word of the target content information refers to that by deleting or modifying operation, the target content information no longer includes an entity word on which the deleting operation or the modifying operation operates during the editing process.

In an example, during the editing process of the target content information, the terminal device may determine whether the entity word is added or reduced in real time according to the word corresponding to the editing operation by using a predetermined entity word recognition method. If it is determined that an entity word is added to the target content information, it may be determined whether the added entity word is an entity word that has appeared in the target content information before. If yes, it is considered that no entity word has been added to the target content information, and if no, it is considered that an entity word has been added to the target content information. If it is determined that the target content information has reduced an entity word, it may be determined whether the target content information still stores the same entity word. If yes, no entity word has been reduced from the target content information, and if no, an entity word has been reduced from the target content information.

In another example, during the editing process of the target content information, the terminal device may send the editing operation information to a server, and according to the editing operation information and historical content information of the target content information, the server detects, based on a predetermined entity word recognition method, whether the entity word in the target content information changes in real time.

After detecting that the entity word of the target content information changes, the target entity word indicated by the change may be matched with the predetermined entry. If the matching succeeds, the entry that successfully matches the target entity word is used as the target entry.

If the change is that the target entity word is added to the target content information, correspondingly, at least part of the content of the target entry is added to the entry information.

If the change is that the target entity word is reduced in the target content information, correspondingly, the information of the target entry is reduced in the entry information.

In practice, at least part of the content of the entry may be added or reduced in the sub-display region corresponding to an entry category according to the entry category corresponding to the target entry.

In these embodiments, during the editing process performed by the editor of the target content information on the content information, the entry of the target content information involved in the editing process is dynamically added or reduced in real time, so that dynamic updating of the entry information is realized. This facilitates the editor in determining the entry used in the editing process in time for management.

In some embodiments, the method for information processing further comprises the following steps.

Firstly, an entry creation access is displayed in the predetermined region.

Secondly, an entry creation operation performed by a user through the entry creation access is received.

Lastly, a new entry is created based on the entry creation operation.

The user herein may be an editor of the target content information or a viewer of the target content information.

The entry creation access may be set at the top or bottom of the predetermined region.

FIG. 6 is a schematic diagram of an application scenario of the method for information processing according to the present disclosure. As shown in FIG. 6, a display region 601 of target content information in a display interface may display the target content information, and a predetermined region 602 may display entry information of the entry associated with the target content information. The entries displayed in the predetermined region 602 may include entries A1, A2, A3, A4, A5, and so on associated with the target content information. The entry creation access may be displayed in the predetermined region 602, and the entry creation access may be, for example, an entry creation control 603 for opening the entry creation window as shown in FIG. 6. A user may perform a trigger operation on the entry creation control 603.

After receiving the trigger operation performed by a user on the entry creation control 603, an entry creation window 604 may be displayed. The user may input information of an entry to be created in the entry creation window 604, for example, entry name A6 and an entry definition may be input. After the user finishes inputting information of the entry to be created, the entry information may be submitted. After receiving a submitting operation for submitting the created entry information by a user, a new entry may be created. In practice, the executing entity may send the information of the new entry to a server, so that the server records the information of the new entry. The association between the information of the new entry and the target content information is established.

In these embodiments, the entry creation access is provided in the predetermined region, so that when a user edits the target content information or browses the target content information, if the definition of an entry in the target content information needs to be created to assist understanding of the target content information, the user may create a new entry through the entry creation access, thereby providing convenience for the user to create an entry when editing the target content information or browsing the target content information.

In some embodiments, the method for information processing further includes the following steps.

An entity word matching an entry is highlighted in the target content information, based on a received first trigger performed by a user on the entry.

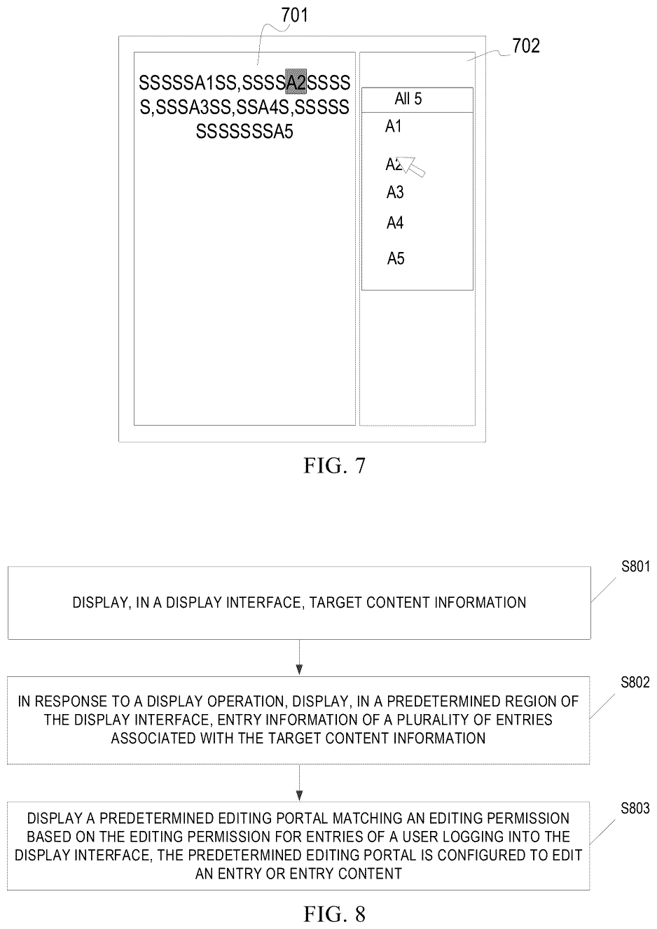

FIG. 7 is a schematic diagram of an application scenario of the method for information processing according to the present disclosure. As shown in FIG. 7, a display region 701 of target content information in a display interface may display the target content information, and a predetermined region 702 may display entry information associated with the target content information. The entries displayed in the predetermined region 702 may include entries A1, A2, A3, A4, A5, and so on associated with the target content information.

A user may perform a first trigger on any entry (for example, A2) displayed in the predetermined region, and an entity word matching the entry may be highlighted in the target content information. The highlighting may include displaying in a different display style from other entries, or having a different background color from other entries. As shown in FIG. 7, when performing the first trigger on the entry A2 in the predetermined region, the background color of the entry A2 in the target content information is different from the background color of other entries.

The first trigger herein may be, for example, a cursor hover performed on the entry, or a touch operation performed on the entry.

In these embodiments, according to the first trigger performed on an entry in the entry information, the entity word matching the entry in the target content information is highlighted, assisting a user in locating the entity word corresponding to the entry in the entry information, so that the user can edit the entity word. This saves the user time of finding the entity word corresponding to the entry.

FIG. 8 is a schematic flowchart 2 of the method for information processing according to the present disclosure. As shown in the figure, the method for information processing includes the following steps.

S801: Target content information is displayed in a display interface.

S802: In response to a display operation, entry information of a plurality of entries associated with the content information is displayed in a predetermined region of the display interface.

The implementations of the foregoing steps S801 and S802 refer to the description of the embodiment shown in FIG. 2, and details are not described herein again.

S803: A predetermined editing access matching an editing permission is displayed based on the editing permission for entries of a user logging into the display interface. The predetermined editing access is configured to edit an entry or entry content.

Different users may have different editing permissions for entries corresponding to the target content information. The editing permission may include an entry editing permission or an entry content editing permission.

At least one user may be assigned to different editing permissions separately, if it is detected that a user logs in to a display interface, the editing permission corresponding to the user may be searched according to the user identifier. Then, a predetermined editing access matching the editing permission is displayed in the entry information display region (that is, the predetermined region) of the display interface according to the editing permission corresponding to the user.

Corresponding to the editing permission, the predetermined editing access may include an entry editing access for editing an entry and an entry content editing entry for editing entry content.

By displaying the predetermined editing access corresponding to the user editing permission to the user, convenience is provided for the user to edit an entry.

In some embodiments, the above step S803 includes the following.

In accordance with a determination that the user has a first editing permission for editing the entry, a keyword setting access for setting a keyword is displayed in the entry information.

That is, when a user has the first editing permission for editing an entry, the predetermined editing access may include the keyword setting access. The keyword setting access is configured to edit a keyword of the target content information.

In these embodiments, the method for information processing further includes the following.

A keyword setting operation of the user is received through the keyword setting access, and a target entry indicated by the keyword setting operation is set as a keyword of the target content information.

The display interface may display the target content information and the entry information. If a user who logs into the display interface has the first editing permission for editing the entry, the keyword setting access may be displayed in the predetermined region. Here, the keyword setting access may be the keyword setting control displayed in the predetermined region.

The keyword setting operation may be performed through the keyword setting access to set the keyword of the target content information.

In an example, a user may perform a right-click operation on an entry, and the keyword setting control is popped up. When a trigger operation performed by a user on the keyword setting control corresponding to an entry is received, the entry may be set as the keyword of the target content information.

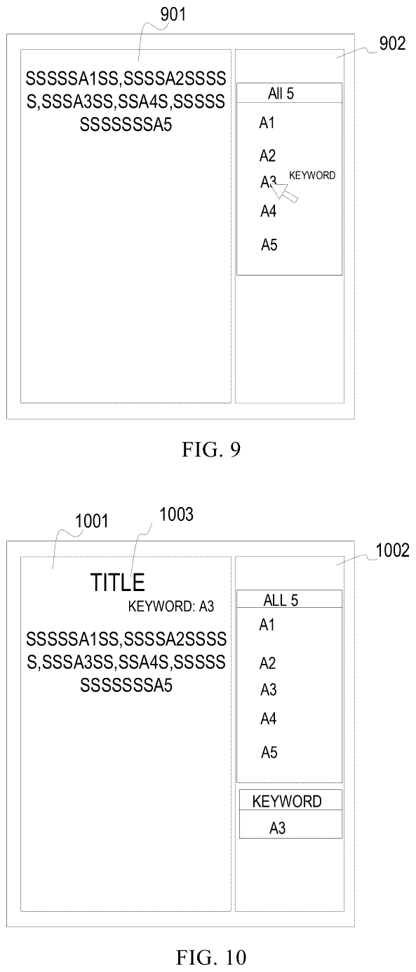

FIG. 9 is a schematic diagram of an application scenario of the method for information processing according to the present disclosure. As shown in FIG. 9, a display region 901 of target content information in a display interface may display the target content information, and a predetermined region 902 may display entry information associated with the target content information. The entries displayed in the predetermined region 902 may include entries A1, A2, A3, A4, A5, and so on associated with the target content information. A user may perform a right-click operation on the entry A3, and correspondingly, a keyword setting control “keyword” 903 may be displayed to the user. It may be understood that the identifier of the keyword setting control may include text, a graphic, a symbol, or the like. The user performs a trigger operation (for example, a click operation) on the keyword setting control so that the entry A3 may be set as the keyword of the target content information.

In an example, the keyword setting control may be displayed in the predetermined region, and after a user performs a trigger operation on the keyword setting control, a cursor may be jumped to the entry list display region, and the user may perform a selecting operation on at least one entry in the entry list. The entry on which the user performs the selecting operation may be used as the keyword of the keyword target content information.

In these embodiments, the keyword setting access is displayed to the user with the first editing permission to edit an entry, and the keyword of the target content information is set according to the keyword setting operation of the user through the keyword setting access, thereby providing convenience for the user to set the keyword of the target content information.

In some embodiments, the method for information processing further comprises: displaying information of the keyword in at least one of:
a first predetermined location of the predetermined region;
a second predetermined location of the target content information; or
an association information display region corresponding to an identifier of the target content information in a content information list page.

In an example, the keyword may be displayed at a first predetermined location of the predetermined region.

The first predetermined location may be a predetermined location in the entry information display region for displaying the information of the keyword. A predetermined identifier for indicating that the location displays the keyword may be displayed at the location.

For example, the first predetermined location may be, for example, at the top or bottom of the predetermined region.

By displaying the information of the keyword in the predetermined region, a user may browse the keyword of the target content information in the predetermined region.

In an example, the information of the keyword may be displayed at a second predetermined location of the target content information.

If the target content information is information of a document, information of the keyword may be displayed at a specified location of the document, for example, under the title of the document.

FIG. 10 is a schematic diagram of an application scenario of the method for information processing according to the present disclosure. As shown in FIG. 10, a display region 1001 of target content information in a display interface may display the target content information, and a predetermined region 1002 may display entry information associated with the target content information. The entries displayed in the predetermined region 1002 may include entries A1, A2, A3, A4, A5, and so on associated with the target content information. The target content information display region 1001 displays a document with a title 1003. The information of the keyword may be displayed under the title 1003 and in the predetermined region 1002.

If the target content information is content information of an instant messaging session, the information of the keyword may be displayed at the top of the instant messaging session.

In this example, by displaying the information of the keyword in the second predetermined location of the target content information, a user browses the information of the keyword in the target content information, so that the user can quickly understand the target content information.

In an example, the association information display region corresponding to the identifier of the target content information in the content information list page.

In this example, the content information list page may be, for example, a document list page. The identification of at least one document may be displayed on the document list page. The information of the keyword may be displayed in an association information display region corresponding to a document identifier.

The information of the keyword may include the keyword.

In this example, by displaying the information of the keyword in the association information display region corresponding to the identifier of the content information in the content information list page, a user may browse the information of the keyword in the content information list page, so that the user can determine to browse the content information of interest in the content information list page according to the information of the keyword.

FIG. 11 is a schematic diagram of an application scenario of the method for information processing according to the present disclosure. As shown in FIG. 11, a content information list page 1101 is displayed in a display interface. The subject of the plurality of content information may be displayed in the content information list page 1101. If the content information is a document, the content information list page displays a document list composed of subjects of the plurality of documents, and the subject of a document may be the title of the document. The document list in FIG. 11 includes “document title 1”, “document title 2”, and “document title 3”. The document list page further includes information displaying the keyword of the document on the right side of the document title, for example, information of keyword “keyword A3” corresponding to “document title 1”; information of keyword “keyword XX” corresponding to “document title 2”; information of keyword “keyword XX” corresponding to “document title 3”. Here, “XX” refers to any one or more words.

In some embodiments, the plurality of entries comprise a polysemous entry, and the polysemous entry has a plurality of definitions.

In these embodiments, the above step S803 includes:
in accordance with a determination that the user has a first editing permission for editing the entry, displaying a target definition setting access in a display region corresponding to the polysemous entry.

The display region corresponding to the polysemous entry herein may display information of a plurality of definitions corresponding to the polysemous entry. Specifically, at least part of the content of respective definitions of the plurality of definitions may be displayed.

In an example, the target definition setting access may be displayed in the display region of each definition. The target definition setting access herein may be, for example, a target definition setting control. A user may set the target definition corresponding to the polysemous entry through the target definition setting access.

In these embodiments, the method for information processing further includes the following steps.

Firstly, a target definition setting operation of the user is received through the target definition setting access.

The target definition setting operation may be, for example, a trigger operation performed on the target definition setting control corresponding to a definition of a polysemous entry.

After receiving the trigger operation performed by the user on the target definition setting control, the executing entity may use the definition as the target definition of the polysemy.

Secondly, a target definition indicated by the target definition setting operation is highlighted in the polysemous entry display region.

For example, the target definition is displayed on top of the polysemous entry display region; or a display style different from other definitions is set for the target definition; or a background color different from other definitions is set for the target definition.

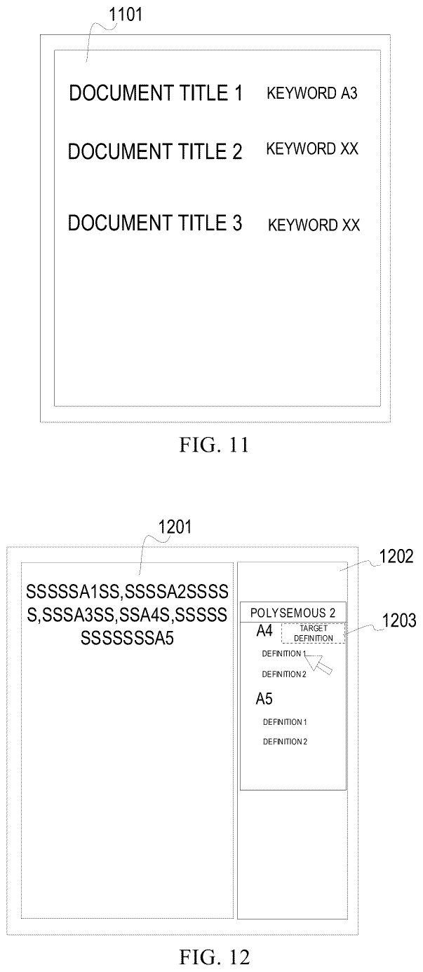

FIG. 12 is a schematic diagram of an application scenario of the method for information processing according to the present disclosure. As shown in FIG. 12, a display region 1201 of target content information in a display interface may display the target content information, and a predetermined region 1202 may display entry information associated with the target content information. The entries displayed in the predetermined region 1202 may include entries A4 and A5 corresponding to a polysemy category. The entry A4 has a definition 1 and a definition 2. The entry A4 has definition 1 and definition 2. A user may perform a target definition setting operation on a definition of an entry in the predetermined region. For example, a predetermined trigger operation (for example, a right-click) is performed on the display region, so that a target definition setting control for setting the definition to the target definition may be displayed. As shown in FIG. 12, a user may perform a right-click operation on the definition 1 of the polysemy A4, and a target definition setting control “target definition” 1203 may be displayed. A user may perform a trigger operation on the target definition setting control 1203, so that the definition 1 of the polysemy A4 may be used as the target definition of the polysemy A4. It may be understood that the identifier “target definition” of the target definition setting control displayed in the figure is merely an example identifier. In practice, the identifier of the target definition setting control may be any identifier including text, a graphic, or a symbol.

In these embodiments, the target definition may be set for the polysemy through the target definition setting access, so that the user can conveniently browse the definitions that should be taken by the polysemy appearing in the target content information, thereby helping the user to quickly understand the target content information.

In some embodiments, the S803 comprises: in accordance with a determination that the user has a second editing permission for editing content of the entry, displaying, in the entry information, a second editing access for entry content.

the second editing access comprises one of: a definition editing access for creating a new definition for an existing entry, or a definition editing access for creating a definition for an unknown entry displayed in the entry information.

In these embodiments, the aforementioned user may be a browsing user of the target content information. The browsing user may have the second editing permission to edit the content of the entry. That is, a user with permission to edit the content of the entry may edit the entry at the level of the content of the entry.

In an example, the browsing user may create a new definition for an existing entry. Specifically, for each entry, a definition editing control may be displayed in the display region corresponding to the entry. The browsing user may click on the definition editing control to display the definition editing window. The browsing user may enter a new definition in the displayed definition editing window.

In this example, by providing the definition editing control to a user with the second editing permission to the content of the entry, the user may input a new definition for the entry, thereby helping to refine the definition of the entry corresponding to the target content information, which may further facilitate understanding of the target information content by the user.

In an example, when the user with the second editing permission for editing the content of the entry browses the target content information, an unknown entry in the target content information may be displayed in the entry information displayed in the display interface. The unknown entry may be an entry in the target content information that is not successfully matched with an entry library.

These unknown entries may be displayed in a sub-display region corresponding to an “unknown entry” category. For these unknown entries, a definition editing access may be displayed in a display region corresponding to the unknown entries, for example, a definition editing control for editing a definition. A user may click the aforementioned example editing control to display the definition editing window. A user may enter a definition in the definition editing window.

In this example, the definition editing control for editing an unknown entry is displayed to the user with the second editing permission to an entry, so that the user can edit the definition of the unknown entry conveniently, which improves the definition of the unknown entry in the target content information, and facilitates the understanding of the target content information by other users.

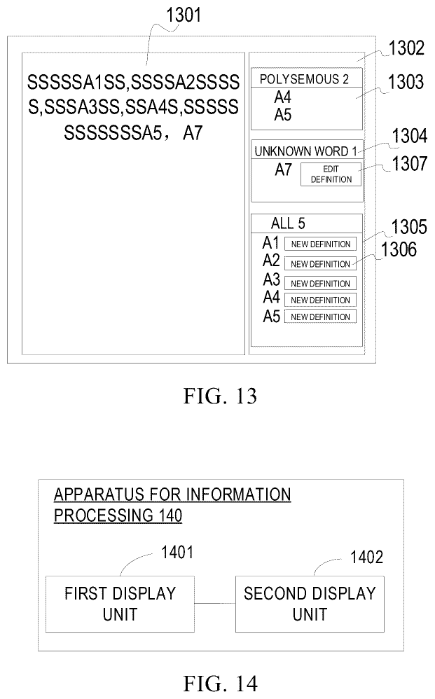

FIG. 13 is a schematic diagram of an application scenario of the method for information processing according to the present disclosure. As shown in FIG. 13, a user logging into a display interface may have a second editing permission for editing the content of the entry. The user here may be, for example, a browsing user. A display region 1301 of target content information in the display interface may display target content information, and a predetermined region 1302 may display entry information associated with the target content information. The predetermined region 1302 may display the entry information by category, for example, a plurality of entries associated with the content information are divided into a polysemy category and an unknown word category, which are displayed in sub-display regions 1303 and 1304, respectively. The polysemy category includes polysemy A4 and A5. The unknown word category includes A7. All entry information, such as entries A1, A2, A3, A4, and A5, are collectively displayed in a sub-display region 1305. For entries A1, A2, A3, A4, and A5 for which definitions have been created, a definition editing control that provides a new definition for these entries may be displayed in the predetermined region 1302, as shown by “new definition” 1306 in FIG. 13. A user may perform a trigger operation on the definition editing control to pop up a new definition editing window. The user may enter a supplemental definition in the new definition editing window. For an unknown entry, a definition editing control may be displayed in the predetermined region, as shown by “edit definition” 1307 in FIG. 13, the user may trigger the definition editing control to pop up the definition editing window, and the user may edit the definition for the unknown entry in the definition editing window.

Corresponding to the method for information processing of the embodiment shown in FIG. 2, FIG. 14 is a structural block diagram of an apparatus for information processing according to the embodiments of the present disclosure. For ease of illustration, only the parts related to embodiments of the present disclosure are shown. Referring to FIG. 14, the apparatus 140 comprises a first display unit 1401 and a second display unit 1402.

The first display unit 1401 is configured to display, in a display interface, target content information.

The second display unit 1402 is configured to, in response to a display operation, display, in a predetermined region of the display interface, entry information of a plurality of entries associated with the target content information.

In an embodiment of the present disclosure, the plurality of entries belong to a plurality of categories, and the second display unit 1402 is further configured to display the entry information of the plurality of entries by category; and/or display an entry list comprising at least part of content of respective entries in the plurality of entries.

In an embodiment of the present disclosure, the categories to which the plurality of entries belong comprise an inappropriate expression category and/or a category not recommended for use; and the second display unit 1402 is further configured to display, in the predetermined region, a modification control for indicating modification of an entry belonging to the inappropriate expression category and/or the category not recommended for use.

In an embodiment of the present disclosure, respective entries correspond to respective definitions, and the second display unit 1402 is further configured to, in response to receiving a display instruction executed on an entry, display a display window of the entry; and display, in the display window, definition information of the entry.

In an embodiment of the present disclosure, the apparatus for information processing further comprises a dynamic adjusting unit (not shown in the figure). The dynamic adjusting unit is configured to detect an entity word added or reduced in the target content information during an editing process of the target content information; and in accordance with a determination that the entity word matches a predetermined entry library, dynamically add or reduce, in the predetermined region, an entry corresponding to the entity word, based on a detection result.

In an embodiment of the present disclosure, the apparatus for information processing further comprises an entry creating unit (not shown in the figure). The entry creating unit is configured to display, in the predetermined region, an entry creation access; receive an entry creation operation performed by a user through the entry creation access; and create a new entry based on the entry creation operation.

In an embodiment of the present disclosure, the second display unit 1402 is further configured to highlight, in the target content information, an entity word matching an entry, based on a received first trigger performed by a user on the entry.

In an embodiment of the present disclosure, the second display unit 1402 is further configured to display a predetermined editing access matching an editing permission based on the editing permission for entries of a user logging into the display interface. The predetermined editing access is configured to edit an entry or entry content.

In an embodiment of the present disclosure, the second display unit 1402 is further configured to, in accordance with a determination that the user has a first editing permission for editing the entry, display, in the entry information, a keyword setting access for setting a keyword. The apparatus for information processing further comprises a keyword setting unit (not shown in the figure). The keyword setting unit is configured to receive a keyword setting operation of the user through the keyword setting access, and set a target entry indicated by the keyword setting operation as a keyword of the target content information.

In an embodiment of the present disclosure, the apparatus for information processing further comprises a keyword display unit (not shown in the figure). The keyword display unit is configured to display information of the keyword in at least one of: a first predetermined location of the predetermined region; a second predetermined location of the target content information; or an association information display region corresponding to an identifier of the target content information in a content information list page.

In an embodiment of the present disclosure, the plurality of entries comprise a polysemous entry, and the polysemous entry has a plurality of definitions. The second display unit 1402 is further configured to, in accordance with a determination that the user has a first editing permission for editing the entry, display a target definition setting access in a display region corresponding to the polysemous entry. The apparatus for information processing further comprises a target definition setting unit (not shown in the figure). The target definition setting unit is configured to receive a target definition setting operation of the user on a polysemous entry through the target definition setting access; and highlight, in the polysemous entry display region, a target definition indicated by the target definition setting operation.

In an embodiment of the present disclosure, the second display unit 802 is further configured to, in accordance with a determination that the user has a second editing permission for editing content of the entry, display, in the entry information, a second editing access for entry content.

The second editing access comprises one of: a definition editing access for creating a new definition for an existing entry, or a definition editing access for creating a definition for an unknown entry displayed in the entry information.

In order to achieve the above embodiments, the embodiments of the present disclosure further provide an electronic device.

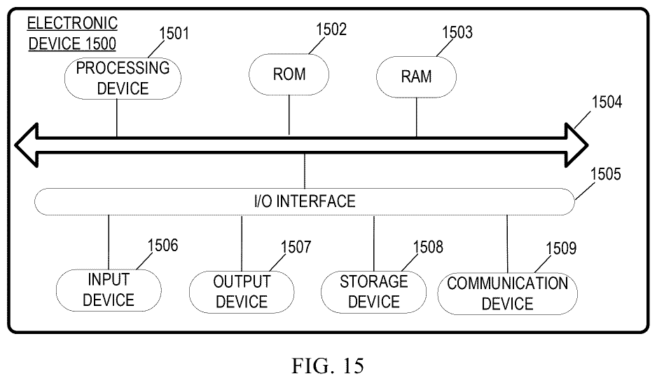

FIG. 15 shows a schematic structural diagram of an electronic device 1500 suitable for implementing the embodiments of the present disclosure, and the electronic device 1500 may be an extended reality device, a terminal device or a server serving an extended reality device. The terminal device may include, but is not limited to, a mobile terminal such as a mobile phone, a notebook computer, a digital broadcast receiver, a personal digital assistant (PDA), a portable android device (PAD), a portable media player (PMP), an in-vehicle terminal (for example, an in-vehicle navigation terminal), and a fixed terminal such as a digital TV, a desktop computer, or the like. The electronic device shown in FIG. 15 is merely an example, and should not impose any limitation on the functions and scope of use of the embodiments of the present disclosure.

As shown in FIG. 15, the electronic device 1500 may include a processing device (for example, a central processing unit, a graphics processing unit, or the like) 1501, which may perform various appropriate actions and processing according to a program stored in a read only memory (ROM) 1502 or a program loaded into a random access memory (RAM) 1503 from a storage device 1508. In the RAM 1503, various programs and data required by the operation of the electronic device 1500 are also stored. The processing device 1501, the ROM 1502, and the RAM 1503 are connected to each other via a bus 1504. An input/output (I/O) interface 1505 is also connected to the bus 1504.

Generally, the following devices may be connected to the I/O interface 1505: an input device 1506 including, for example, a touch screen, a touch pad, a keyboard, a mouse, a camera, a microphone, an accelerometer, a gyroscope, or the like; an output device 1507 including, for example, a liquid crystal display (LCD), a speaker, a vibrator, or the like; the storage device 1508 including, for example, a magnetic tape, a hard disk, or the like; and a communication device 1509. The communication device 1509 may allow the electronic device 1500 to communicate wirelessly or wired with other devices to exchange data. While FIG. 15 shows the electronic device 1500 with various devices, it should be understood that it is not required to implement or have all illustrated devices. More or fewer devices may alternatively be implemented or provided.

In particular, according to the embodiments of the present disclosure, the process described above with reference to the flowchart may be implemented as a computer software program. For example, the embodiments of the present disclosure include a computer program product comprising a computer program carried on a computer-readable medium, and the computer program comprises program code for performing the method shown in the flowchart. In such embodiments, the computer program may be downloaded and installed from the network through the communication device 1509, or installed from the storage device 1508, or installed from the ROM 1502. When the computer program is executed by the processing device 1501, the foregoing functions defined in the method of the embodiments of the present disclosure are performed.

It should be noted that the computer-readable medium described above may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in combination with an instruction execution system, apparatus, or device. In the present disclosure, the computer-readable signal medium may include a data signal propagated in a baseband or as part of a carrier, where the computer-readable program code is carried. Such a propagated data signal may be in a variety of forms including, but not limited to, an electromagnetic signal, an optical signal, or any suitable combination thereof. The computer-readable signal medium may also be any computer-readable medium other than a computer-readable storage medium that may send, propagate, or transmit a program for use by or in combination with an instruction execution system, apparatus, or device. The program code included in the computer-readable medium may be transmitted with any suitable medium, including, but not limited to: a wire, an optical cable, radio frequency (RF), and the like, or any suitable combination thereof.

The computer-readable medium described above may be included in the electronic device; or may be separately present without being assembled into the electronic device.

The computer-readable medium carries one or more programs, and when the one or more programs are executed by an electronic device, the electronic device is caused to perform the method shown in the foregoing embodiments.

Computer program code for performing the operations of the present disclosure may be written in one or more programming languages, including object-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer, the remote computer may be connected to a user computer through any kind of network, including a local area network (LAN) or a wide area network (WAN), or may be connected to an external computer (for example, using an Internet service provider for Internet connection).

The flowcharts and block diagrams in the figures illustrate the architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than those illustrated in the figures. For example, two consecutively represented blocks may actually be performed substantially in parallel, which may sometimes be performed in the reverse order, depending on the functionality involved. It is also noted that each block in the block diagrams and/or flowcharts, as well as a combination of blocks in the block diagrams and/or flowcharts, may be implemented with a dedicated hardware-based system that performs a specified function or operation, or may be implemented in a combination of dedicated hardware and computer instructions.

The units involved in the embodiments of the present disclosure may be implemented in software, or may be implemented in hardware. The name of a unit does not necessarily constitute a limitation on the unit itself in certain circumstances, for example, the first display unit may also be described as “a unit for displaying the target content information in the display interface”.

The functions described above may be performed, at least in part, by one or more hardware logic components. For example, without limitation, example types of hardware logic components that may be used include field programmable gate array (FPGA), application specific integrated circuit (ASIC), application specific standard product (ASSP), system-on-a-chip (SOC), complex programmable logic devices(CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or device, or any suitable combination of the foregoing. More specific examples of machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above description is merely an illustration of the preferred embodiments and the applied principles of the present disclosure. It should be understood by those skilled in the art that the scope of the present disclosure is not limited to the technical solutions of the specific combination of the above technical features, and should also cover other technical solutions formed by any combination of the above technical features or their equivalent features without departing from the above-disclosed concept, for example, technical solutions formed by substituting the aforementioned features with technical features that have similar functions to those disclosed (but not limited to) in the present disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Some features described in the context of a separate embodiment may also be implemented in combination in a single embodiment. Conversely, the various features described in the context of a single embodiment may also be implemented in multiple embodiments individually or in any suitable sub-combination.

Although the present subject matter has been described in language specific to structural features and/or method logic acts, it is to be understood that the subject defined in the appended claims is not necessarily limited to the specific features or acts described above. Rather, the specific features and acts described above are merely example forms of implementing the claims.

1-16. (canceled)

17. A method for information processing, comprising:
displaying, in a display interface, target content information; and
in response to a display operation, displaying, in a predetermined region of the display interface, entry information of a plurality of entries associated with the target content information.

18. The method of claim 17, wherein the plurality of entries belong to a plurality of categories, and
displaying, in the predetermined region of the display interface, the entry information of the plurality of entries associated with the target content information comprises:
displaying the entry information of the plurality of entries by category; and/or
displaying an entry list comprising at least part of content of respective entries in the plurality of entries.

19. The method of claim 18, wherein the categories to which the plurality of entries belong comprise an inappropriate expression category and/or a category not recommended for use; and
the method further comprises:
displaying, in the predetermined region, a modification control for indicating modification of an entry belonging to the inappropriate expression category and/or the category not recommended for use.

20. The method of claim 17, wherein respective entries correspond to respective definitions, and the method further comprises:
in response to receiving a display instruction executed on an entry, displaying a display window of the entry; and
displaying, in the display window, definition information of the entry.

21. The method of claim 17, further comprising:
detecting an entity word added or reduced in the target content information during an editing process of the target content information; and
in accordance with a determination that the entity word matches a predetermined entry library, dynamically adding or reducing, in the predetermined region, an entry corresponding to the entity word, based on a detection result.

22. The method of claim 17, further comprising:
displaying, in the predetermined region, an entry creation access;
receiving an entry creation operation performed by a user through the entry creation access; and
creating a new entry based on the entry creation operation.

23. The method of claim 17, further comprising:
highlighting, in the target content information, an entity word matching an entry, based on a received first trigger performed by a user on the entry.

24. The method of claim 17, further comprising:
displaying a predetermined editing access matching an editing permission based on the editing permission for entries of a user logging into the display interface, the predetermined editing access being configured to edit an entry or entry content.

25. The method of claim 24, wherein displaying the predetermined editing access matching the editing permission based on the editing permission for entries of the user logging into the display interface comprises:
in accordance with a determination that the user has a first editing permission for editing the entry, displaying, in the entry information, a keyword setting access for setting a keyword; and the method further comprising:
receiving a keyword setting operation of the user through the keyword setting access, and setting a target entry indicated by the keyword setting operation as a keyword of the target content information.

26. The method of claim 17, wherein the target content information corresponds to a keyword, and the method further comprises:
displaying information of the keyword in at least one of:
a first predetermined location of the predetermined region;
a second predetermined location of the target content information; or
an association information display region corresponding to an identifier of the target content information in a content information list page.

27. The method of claim 24, wherein the plurality of entries comprise a polysemous entry, the polysemous entry has a plurality of definitions; and
displaying the predetermined editing access matching the editing permission based on the editing permission for entries of the user logging into the display interface comprises:
in accordance with a determination that the user has a first editing permission for editing the entry, displaying a target definition setting access in a display region corresponding to the polysemous entry; and the method further comprising:
receiving a target definition setting operation of the user on a polysemous entry through the target definition setting access; and
highlighting, in the polysemous entry display region, a target definition indicated by the target definition setting operation.

28. The method of claim 24, wherein displaying the predetermined editing access matching the editing permission based on the editing permission for entries of the user logging into the display interface comprises:
in accordance with a determination that the user has a second editing permission for editing content of the entry, displaying, in the entry information, a second editing access for entry content; and
the second editing access comprising one of: a definition editing access for creating a new definition for an existing entry, or a definition editing access for creating a definition for an unknown entry displayed in the entry information.

29. An electronic device, comprising: a processor and a memory;
the memory storing computer-executable instructions;
wherein the processor executes the computer-executable instructions stored in the memory, causing the processor to perform acts comprising:
displaying, in a display interface, target content information; and
in response to a display operation, displaying, in a predetermined region of the display interface, entry information of a plurality of entries associated with the target content information.

30. The electronic device of claim 29, wherein the plurality of entries belongs to a plurality of categories, and
displaying, in the predetermined region of the display interface, the entry information of the plurality of entries associated with the target content information comprises:
displaying the entry information of the plurality of entries by category; and/or
displaying an entry list comprising at least part of content of respective entries in the plurality of entries.

31. The electronic device of claim 30, wherein the categories to which the plurality of entries belongs comprise an inappropriate expression category and/or a category not recommended for use; and
the acts further comprise:
displaying, in the predetermined region, a modification control for indicating modification of an entry belonging to the inappropriate expression category and/or the category not recommended for use.

32. The electronic device of claim 29, wherein respective entries correspond to respective definitions, and the acts further comprise:
in response to receiving a display instruction executed on an entry, displaying a display window of the entry; and
displaying, in the display window, definition information of the entry.

33. The electronic device of claim 29, the acts further comprising:
detecting an entity word added or reduced in the target content information during an editing process of the target content information; and
in accordance with a determination that the entity word matches a predetermined entry library, dynamically adding or reducing, in the predetermined region, an entry corresponding to the entity word, based on a detection result.

34. The electronic device of claim 29, the acts further comprising:
displaying, in the predetermined region, an entry creation access;
receiving an entry creation operation performed by a user through the entry creation access; and
creating a new entry based on the entry creation operation.

35. The electronic device of claim 29, the acts further comprising:
highlighting, in the target content information, an entity word matching an entry, based on a received first trigger operation performed by a user on the entry.

36. A non-transitory computer-readable storage medium, wherein the computer-readable storage medium stores computer-executable instructions which, when executed by a processor, implement acts comprising:
displaying, in a display interface, target content information; and
in response to a display operation, displaying, in a predetermined region of the display interface, entry information of a plurality of entries associated with the target content information.
